(19) United States
(12) Patent Application Publication
(10) Pub. No.: US 2001/0030679 A1
(43) Pub. Date: Oct. 18, 2001

(54) INK-JET PRINTER AND PRINTING METHOD THEREFOR

(76) Inventors: HIDEMI KUBOTA, TOKYO (JP); ISAO KIMURA, KAWASAKI-SHI (JP); HIROYUKI MAEDA, YOKOHAMA-SHI (JP)

Correspondence Address: FITZPATRICK CELLA HARPER & SCINTO, 30 ROCKEFELLER PLAZA, NEW YORK, NY, 10112, US

(21) Appl. No.: 08/982,452

(22) Filed: Dec. 2, 1997

(30) Foreign Application Priority Data
Dec. 3, 1996 (JP) 8-323073

(51) Int. Cl. B41J 2/01

(52) U.S. Cl. 347/102

(57) ABSTRACT

Ink permeation with respect to paper differs in accordance with the temperature of the paper. As the temperature increases, the permeation increass, thus the ink immediately permeates into the paper as soon as it is attached to the paper. Accordingly, in a color ink-jet printer, upon printing, a portion in a print line of the paper is heated in accordance with control information. As ink quickly permeates at the heated portion, after printing with ink of a color, subsequent ink of another color does not mix with the previous color ink, thus bleeding can be prevented. Further, an area of character or the like is not heated, so that ink does not quickly permeate, thus feathering of outlines can be prevented.

### BACKGROUND OF THE INVENTION

This invention relates to ink-jet printer and printing method therefor which perform printing by discharging ink as ink droplets from an discharge orifice such that the ink droplets are attached to the surface of a print medium and, more particularly to ink-jet printer and printing method therefor which prevent feathering and bleeding, and realize good color development, further, form a high quality image in accordance with image type.

### DESCRIPTION OF RELATED ART

Conventionally, as ink for ink-jet printing, mainly water ink is used for the purposes of safety, prevention of bad smell and the like. A known example of the water ink is obtained by dissolving or dispersing various water dyes or pigments in water, or water and water-soluble organic solvent, and adding wetting agent, dye dissolution accelerating agent, antifungal agent and the like, to the solvent, in accordance with necessity. The ink-jet printing method has many advantages as follows: high-speed printing can be performed by discharging such ink as several thousands of ink droplets per second; printing can be performed with reduced noise; color printing can be easily performed; printing can be performed in high resolution; and normal paper can be used in printing. Accordingly, the ink-jet printing method has become very popular in recent years.

Further, with the lowered prices and high performance of personal computers and the standardization of GUI (Graphical User Interface) environment, there are increasing needs for good color development, high quality, good durability, high resolution and high speed in image printing by printers. For this reason, technical ideas to keep color matter on the surface of paper as much as possible, to form sharp edges of print dots, and to reduce ink spread, that is, feathering, bleeding or the like have been proposed, and related products have been sold. These techniques are briefly classified into a printing technique which uses a print sheet called normal paper as a print medium, and a printing technique which uses paper for ink-jet printing. The normal paper, which is used in a copier and the like, is produced with low cost, and has practically excellent characteristics. Further, in recent years, paper for copiers which controls ink spread and has a certain degree of adaptability to ink-jet printing has been introduced.

To print a really high-quality image, it is necessary to use a special paper for ink-jet printing. The special paper is obtained by coating the surface layer of paper with various materials. By using this paper, ink absorption, color development and the like are controlled, and high-quality images and characters are represented. This is a very excellent method to provide high-quality images, however, it has various practical drawbacks as follows: the cost of the special paper is high; notes cannot be easily written by a pencil or pen on the coated special paper surface; the special paper provides an unpleasant touch; the special paper cannot be used in a copier; and the weight of the paper is heavier than normal paper.

Generally, mainly normal paper is used in view of the above drawbacks of the special paper, however, it is necessary to use specialized ink for the normal paper. Ink which quickly permeates into paper is inappropriate to print sharp character images. However, if the permeation is prevented too much, the ink remains on the paper surface in a liquid state, which might dirty a finger or the like touched the ink after printing, further, which causes a blur by contact with the finger or the like. Accordingly, ink for printing by using normal paper is prepared in consideration of the balance between the permeability and non-permeability such that sharp characters can be printed. When printing only characters, usually black characters are printed on a white base of the paper. In this case, the ink for black characters is prepared as above.

On the other hand, color printers have been widely used in recent years. In case of color printing, the situation is greatly different. For example, in case of printing characters on a uniform color base, if ink in which permeability with respect to paper is suppressed to a certain degree as above is used, since color ink mixes with another color ink at a portion where the different colors are in contact, which causes so-called feathering or bleeding. The feathering and bleeding greatly degrade image quality. Accordingly, the trend of ink in recent years in color ink-jet printing is ink which contains surface active agent and which permeates into paper very quickly. In use of this ink, if printing is performed by using first color ink and next printing is performed by using second color ink, the first color ink used in the first printing has already permeated into paper at the next printing. This prevents feathering and bleeding, and prints a high-quality image on normal paper. However, in a case where black characters or color characters are printed on normal paper, the edges of the characters are not sharp because the ink permeates into the paper and at the same time the ink spreads along the paper surface. Further, as the ink permeates into the inside of the paper, printing density is lowered to a certain degree due to light scattered by fiber of the paper surface. The scattered light produces a color image in a low-saturation. For this reason, an image printed by so-called ink-jet printing on normal paper is poor in comparison with an image printed on paper for ink-jet printing.

Then, to obtain a image with high-quality upon ink-jet printing on normal paper, a technique to heat the print medium from the rear surface side of the medium, before printing, during the printing, and after the printing, has been proposed.

This technique is disclosed in, e.g., Japanese Patent Application Laid-Open No. 56-82290. Further, Japanese Patent Application Laid-Open Nos. 62-135368 and 62-173259 propose providing a plurality of heaters. However, these techniques aim to finally realize a unique temperature in the entire area of a print medium regarding a head scanning direction, although they perform heating corresponding to the type of print medium or pre-heating the print medium in sheet conveyance direction. Further, Japanese Patent Application Laid-Open No. 63-317351 proposes moving a heating area in correspondence with movement of a printhead, thus saving heating energy. However, the heating area is moved in synchronization with the movement of the printhead and in dependence on position information of the printhead. That is, none of these techniques aims to control permeation of ink with respect to the print medium in accordance with image characteristics.

Accordingly, regarding feathering or bleeding, the above technique still has an unremovable problem. To obtain sharp character images in general documents, it is desirable that feathering or bleeding is prevented as much as possible. Characters can be clear if character portions and base portions, e.g., black portions and white base portions, are separated as clearly as possible. So-called business color documents as well as black characters, the feathering or bleeding should be prevented as much as possible. In the business color documents, data in graphical representation such as a circle graph and a bar graph are formed by using various colors to visually assist people's understanding of the documents. Further, in these documents, the base color is not always white but totally or partially another color. In these color documents, actual colors usually have a constant color hue and density in a specific region. Further, the number of colors is not so large. As mentioned above, if printed portions and base portions are clearly separated and feathering or bleeding is prevented as much as possible, high-quality color documents can be obtained, similar to character printing.

However, if a so-called natural image is printed by using this method, the following problem occurs. In a natural image, various colors are used. More specifically, at a very thin color portion, ink is often scattered in a wide area. To scatter ink in a wide area, various methods are employed. For example, if an area has constant color hue and intensity, dots are diffused in a regular pattern. Otherwise, an error diffusion method to diffuse dots by using prior and subsequent data can be used. However, in any method, a portion where high-density ink dots are scattered without spread is conspicuous to a human eye. In the above-mentioned business color documents, visual color data portions usually have uniform print patterns, therefore the ink-scattered portions do not attract attention; however, in natural images, such portions are very unnatural, resulting in images which have excellent color representation but which have a rough-touch and poor quality.

To solve these problems, various methods are used; for example, ink which permeates into a print medium without causing spread, or a special print medium is used. However, these methods are applied to the entire document sheet. That is, it is very difficult to print a document including a character portion which requires sharp edges, a color portion which requires vivid colors without color mixture, and a natural image portion which should avoid rough touch, on so-called normal paper, with high quality.

### SUMMARY OF THE INVENTION

The present invention has been made to solve the above problems, and has its object to provide an ink-jet printer which print-outputs an image containing different types of images such as a natural image and a character image with high quality, and a printing method for the printer.

According to the present invention, the ink-jet printer to attain the foregoing object comprises: heating means for heating a desired area of a print medium; printing means for printing an image by discharging ink droplets onto the print medium; and control means for controlling said heating means and said printing means to heat an area of the print medium in accordance with control information while print an image based on image information by discharging ink droplets onto the heated area.

Further, the printing method to attain the foregoing object comprises: a heat control step of heating an area, designated by control information, on a print medium; and a print control step of printing an image of the area heated at said heat control step.

By the above constructions, printing effects intended by a user can be attained by ink permeation control by totally or partially heating the surface of paper.

Other features and advantages of the present invention will be apparent from the following description taken in conjunction with the accompanying drawings, in which like reference characters designate the same name or similar parts throughout the figures thereof.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIGS. 1 to 3 are line graphs showing changes of contact angle of ink for an ink-jet printer in accordance with temperature and time;

FIG. 4 is a schematic view showing a heater for heating paper according to an embodiment of the present invention;

FIG. 5 is a block diagram showing the construction of the heater;

FIGS. 6A and 6B are schematic views showing the relation among a printhead, a print medium and the heater;

FIG. 7 is an image sample in printing;

FIG. 8 is a schematic view showing another embodiment of the present invention;

FIG. 9 is a perspective view showing the structure of a line-type heater;

FIG. 10 is a cross-sectional view of the line-type heater;

FIGS. 11 and 12 are block diagrams respectively showing the construction of a controller of the line-type heater;

FIGS. 13 to 16 are cross-sectional views of the line-type heater;

FIG. 17 is a schematic view showing an example where a scanning-type thermal head is used;

FIG. 18 is a perspective view showing an ink-jet printer;

FIG. 19 is a perspective view showing the structure of a printhead of the ink-jet printer according to the embodiments;

FIG. 20 is a flowchart showing a procedure of setting feathering control information;

FIG. 21 is a flowchart showing a procedure of controlling the paper heater; and

FIG. 22 and 23 are a timing chart showing an example of a procedure of controlling the paper heater.

### DETAILED DESCRIPTION OF THE PREFERRED EMBODIMENTS

Preferred embodiments of the present invention will now be described in detail in accordance with the accompanying drawings.

### [First Embodiment]

As an embodiment of the present invention, an ink-jet printer which print-outputs an image by heating ink to cause film boiling and discharging ink droplets in accordance with image information to form dots on a print medium will be described. First, prior to the description of the construction of the printer, the composition and temperature characteristics of ink used in the printer will be described. Note that ink spread means feathering, bleeding or the like in the specification as mentioned above.

### <Temperature Characteristics of Ink>

Generally, when liquid is placed on so-called normal paper, the liquid takes two type of movements. One movement is spread in a horizontal direction along the paper surface, and the other movement is permeation in a thickness direction into the inside of the paper. Note that these movements are not independent of each other but are related to each other, therefore, in consideration of differences among paper types, manufacturers and the like, it is difficult to uniformly define these movements.

First, characteristic two types of ink used in the ink-jet printing method will be described. The first ink is used only for character printing. In a case where only characters are printed on so-called normal paper, a required characteristic of the first ink is that permeability with respect to the paper surface is suppressed to a certain degree. If the speed of permeation of the ink with respect to the paper is high, the ink quickly spreads on the paper surface. In this case, the diameter of a dot printed on the paper becomes large, which degrades the resolution. At this time, the ink also permeates into the inside of the paper, i.e., most of the ink moves from the paper surface to the inside of the paper, thus the printing density is lowered. From these two reasons, it is understood that ink with high permeation speed cannot be used because it degrades printing quality of characters. Accordingly, the first ink has a comparatively high surface tension so as to suppress permeation with respect to the paper such that wettability of the fiber of the paper with respect to the ink is suppressed to a lower level.

The second ink is not used for printing characters but for printing images. The feature of an image is that a picture appears on the entire paper surface, different from a case of characters. That is, ink must be uniformly attached to a predetermined area. In a case where the above-described first ink is employed in image printing, a problem occurs if areas of two different colors, for example, are in contact on a border line. Since the permeation of the first ink with respect to the paper is suppressed to a certain degree, after first color ink is applied to the paper surface, second color ink is applied before the first color ink permeates into the paper. On the border line between the two colors, the first color ink and the second color ink are in contact with each other before these liquids permeate into the paper. At this time, the first color ink and the second color ink mix with each other, and the initially intended border line is disturbed. Further, on the border line, if the first color ink has started to permeate into the inside of the paper, the second color ink that has applied to the paper surface in the next printing flows toward the first color ink. Accordingly, a bleeding pattern is formed and the shape of the border is unintentionally disturbed, thus the image quality is remarkably degraded.

Generally, to form an image while preventing the above color mixture, a small amount of surface active agent is added to the ink so as to increase permeation speed with respect to the paper. This is the second ink. However, if the second ink is used for printing characters, the printing quality is degraded and printed characters become illegible. When the second ink droplets are attached to the paper, as the ink quickly permeates into the fiber of the paper by the surface active agent and it quickly spreads along the paper surface as well as the inside of the paper. Therefore, the diameter of print dots becomes very large, thus the density of the print dots is degraded. Characters printed by using this ink have a low density and have non-sharp edges, therefore the quality of the entire document is degraded in comparison with that obtained by other printing methods such as laser-beam printing.

Accordingly, to attain both image quality and character quality, it can be considered to use the first ink for printing characters and the second ink for printing images. Especially, black ink is usually used for printing characters, therefore, it may be arranged such that the first ink is used for printing black color, and the second ink is used for printing the other colors, i.e., cyan, magenta and yellow colors. However, in this method, a problem occurs when black characters are printed on an uniform color base. That is, the black ink spreads on the color base, thus causing feathering. To solve this problem, generally, a small amount of surface active agent is added to the black ink so as to increase permeability with respect to the paper. However, in this method, as the first ink for black characters has increased permeation with respect to the paper, the above-described characteristic of the first ink is lost.

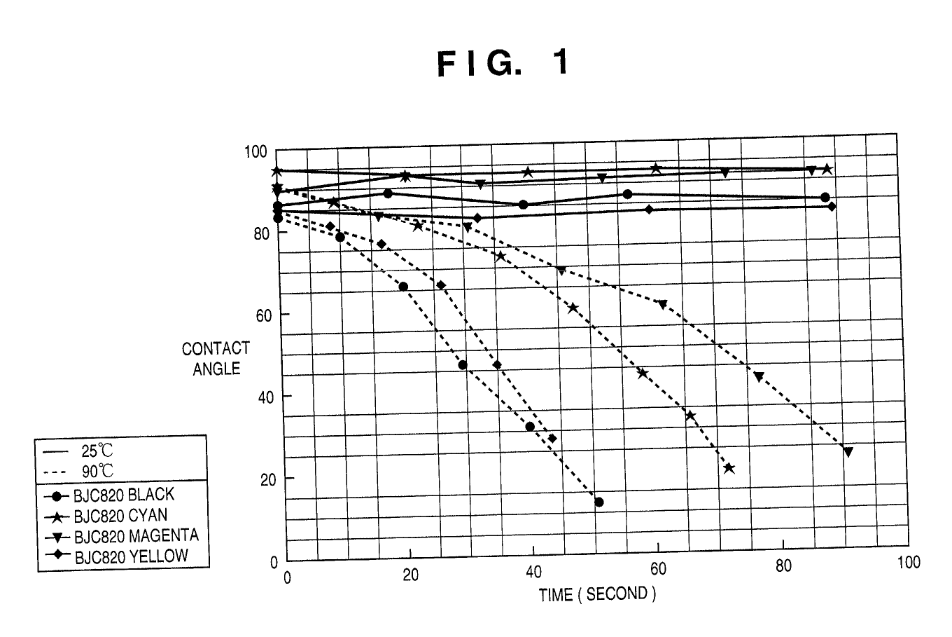

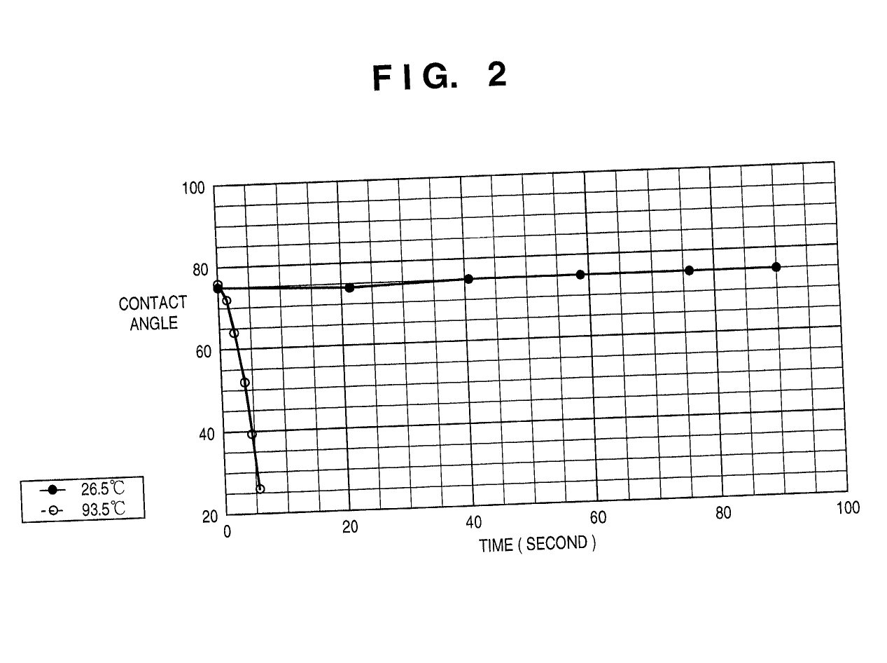

On the other hand, according to the observation by the present inventor, the speed of permeation of liquid dropped on normal paper increases as the temperature rises. FIG. 1 shows the result of measurement of contact angle of color ink for ink-jet printer BJ820J by Canon Kabushiki Kaisha at paper temperatures 25° C. and 90° C. Note that the contact angle here is somewhat different from a contact angle (strictly defined as advance contact angle and reversing contact angle) which is formed at a surface between a solid phase and a gas phase when a liquid is dropped onto the mirror-shaped surface of a solid object of a uniform material. The contact angle in FIG. 1 is an angle of contact among a gas phase, a liquid phase and a solid phase, measured from a side position by contact angle meters CA-D by Kyowa Interface Science Co., Ltd. in a dynamic state where an ink droplet permeates into the inside of paper while it spreads on the paper surface. As it is understood from the graph, at a high temperature, time change of the contact angle is large, and the ink quickly permeates into the inside of the paper. More specifically, it is considered that the time change of the contact angle is large at a high temperature, not because the liquid evaporates at the high temperature and the seeming contact angle is reduced, but because the permeation is quickened since the liquid droplet quickly spreads at the high temperature. FIG. 2 shows the result of experiment by using ink containing a little amount of surface active agent. The composition of the ink employed in the experiment is as follows:

| | |
|---|---|
| food black 2 | 3.0% |
| thiogyglycol | 5.0% |
| glycerol | 5.0% |
| urea | 5.0% |
| isopropyl alcohol | 4.0% |
| acetylene alcohol | 0.1% |
| water | 77.9% |

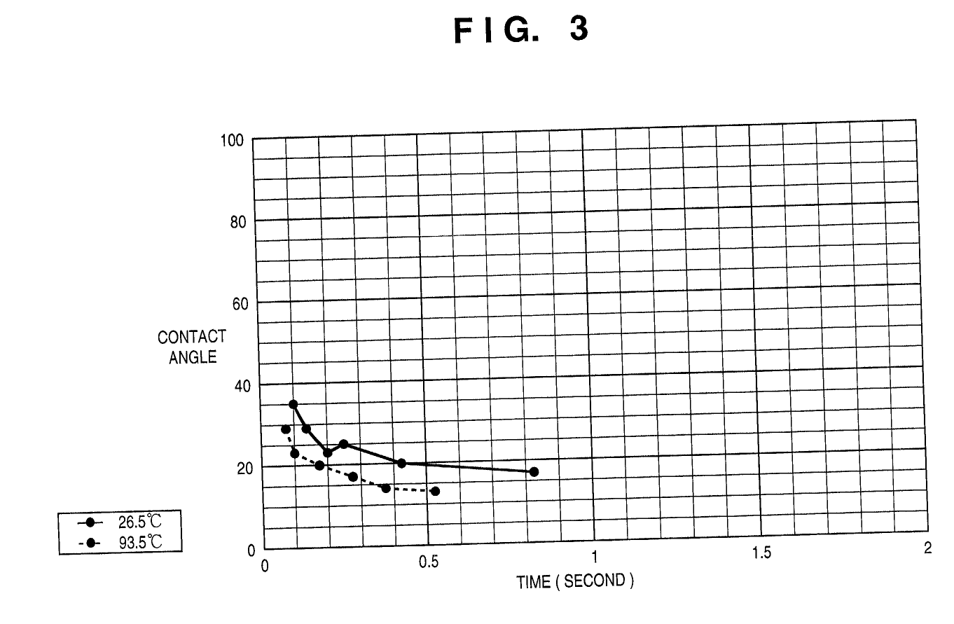

Further, FIG. 3 shows the contact angle of the above ink where the content of acetylene alcohol as the surface active agent is changed to 1%. As this ink has very high permeability, the change of contact angle based on temperature cannot be easily measured accurately. When printing a color image by using this ink, even at a border portion between different colors, a large part of ink which has been first applied to that portion permeates into the paper before the subsequently discharged ink is attached to that portion. Accordingly, the probability of occurrence of feathering or bleeding is comparatively low, and a high-quality image can be obtained. The paper employed in the experiment as shown in FIGS. 1 to 3 is normal paper PB PAPER (No. QKDA4) for copier by Canon Kabushiki Kaisha.

The present embodiment controls the characteristics of ink by heating control in accordance with respective parts of an image, so as to increase printing quality of characters and that of color images, in consideration of the fact that the permeability of liquid changes in accordance with the temperature of an object to which the liquid is applied. In the present embodiment, the ink having the temperature characteristic as shown in FIG. 2 is employed.

### <Ink-Jet Printer>

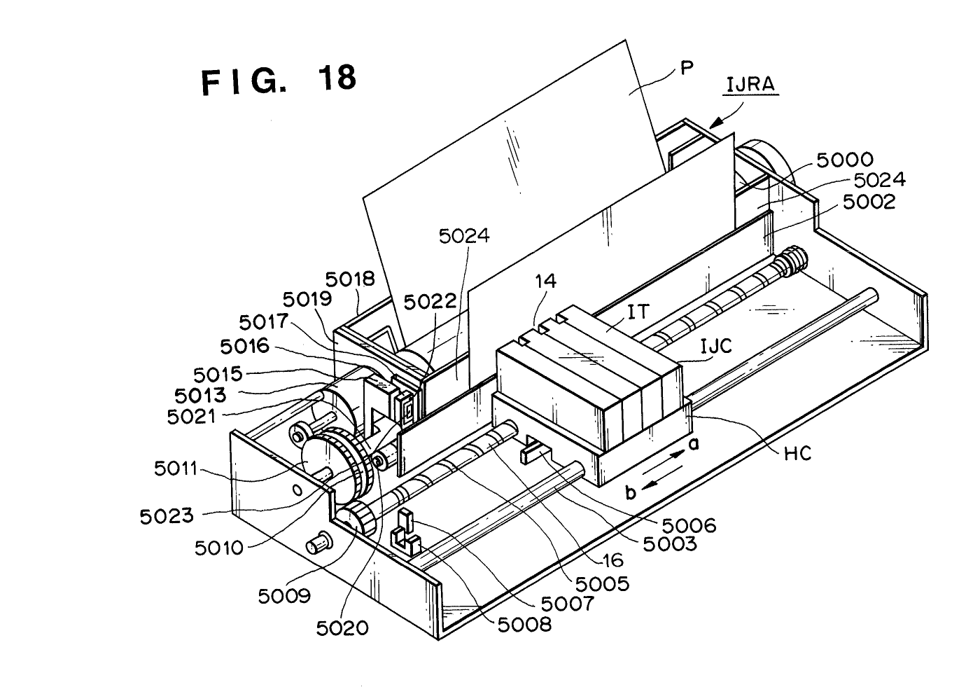

FIG. 18 is a perspective view showing an ink-jet printer IJRA according to the present embodiment. In FIG. 18, a carriage HC is engaged with a spiral groove 5005 of a lead screw 16 which rotates via drive force transmission gears 5009 to 5011 interlocking with forward/reverse rotation of a drive motor 5013. The carriage HC has a pin (not shown) and it is reciprocally moved in directions represented by arrows a and b. The carriage HC has an ink-jet cartridge IJC which comprises a printhead 14 having ink discharge orifices. The printhead 14 is a color ink-jet head where respective Y, M, C and K color heads are arrayed in a scanning direction.

A paper holding plate 5002, opposite to the head 14, presses the print sheet against a platen 5000 along the moving direction of the carriage HC. Further, heaters to be described later are provided on another paper holding plate 5024 which holds the print sheet from back side.

Photocouplers 5007 and 5008 detect a home position for confirming the existence of lever 5006 of the carriage in this area and changing over the rotational direction of motor 5013. A support member 5016 supports a cap member 5022 for capping the front surface of the printhead 14. A suction member 5015 performs suction-restoration of the printhead 14 by sucking the inside of the cap member 5022 via a cap inner opening 5023. A member 5019 allows a cleaning blade 5017 to move in a back-and-forth direction. A main body support plate 5018 supports the member 5019 and the cleaning blade 5017. It is apparent that any well-known cleaning blade is applicable to the printer of the embodiments. Numeral 5021 denotes a lever for starting the sucking operation of the suction-restoration. The lever 5021 moves along the movement of a cam 5020 engaged with the carriage HC. A well-known transmission mechanism such as change-over of a clutch controls a drive force from the drive motor.

When the carriage HC is at the home position area, a desired one of these capping, cleaning and suction-restoration is executed at its corresponding position by the lead screw 16. Any of these processing is applicable to the printer, if a desired processing is performed at a well-known timing.

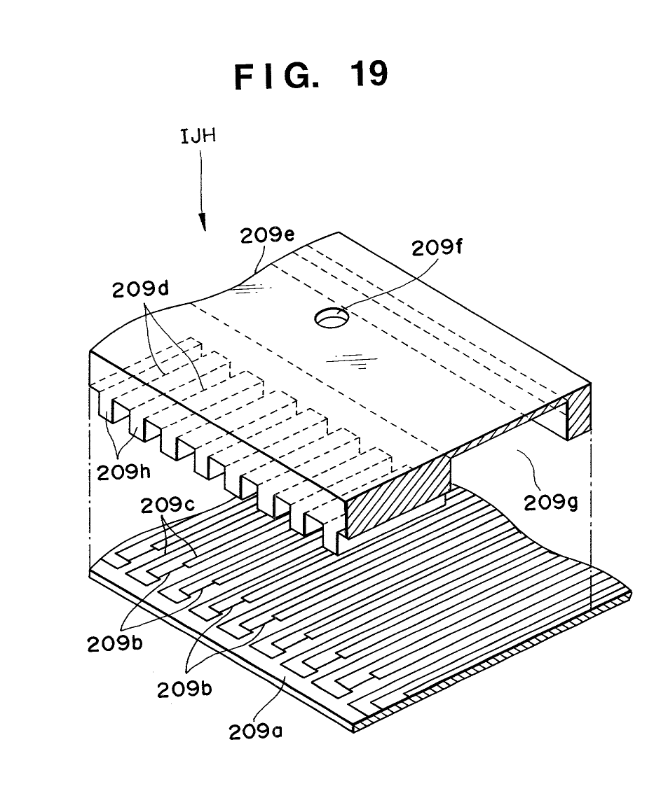

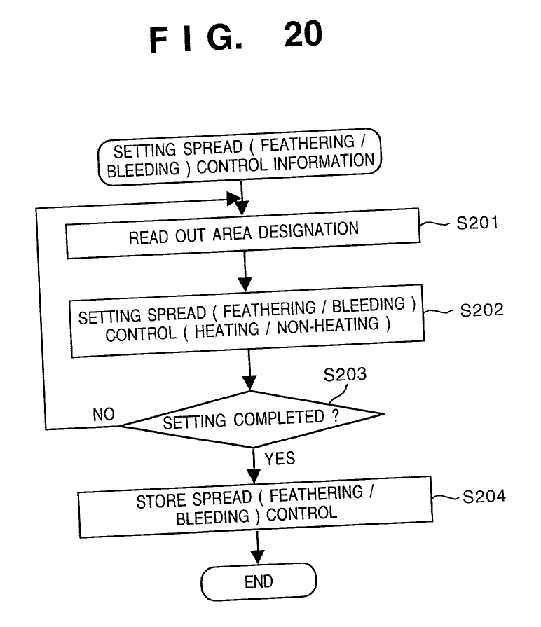

FIG. 19 is a perspective view showing the printhead 14. In FIG. 19, reference numeral 209a denotes a heater board where electrothermal transducers (discharge heaters) 209b and electrodes 209c of aluminum or the like for supplying electric power to the electrothermal transducers 209b are made by film-forming on a silicon substrate. The printhead 14 is assembled by attaching the heater board 209a to a top plate 209e having partition walls for separating liquid channels (nozzles) 209d for ink.

The ink supplied from the ink cartridge IJC via a conduit is filled into a common liquid chamber 209g in the printhead 14 from a supply port 209f provided in the top plate 209e, and introduced into the respective nozzles 209d from the common liquid chamber 209g. The nozzles 209d respectively have an ink discharge orifice 209h. The ink discharge orifices 209h are formed at a predetermined pitch in a sheet conveyance direction opposite to the print sheet.

### <Heater>

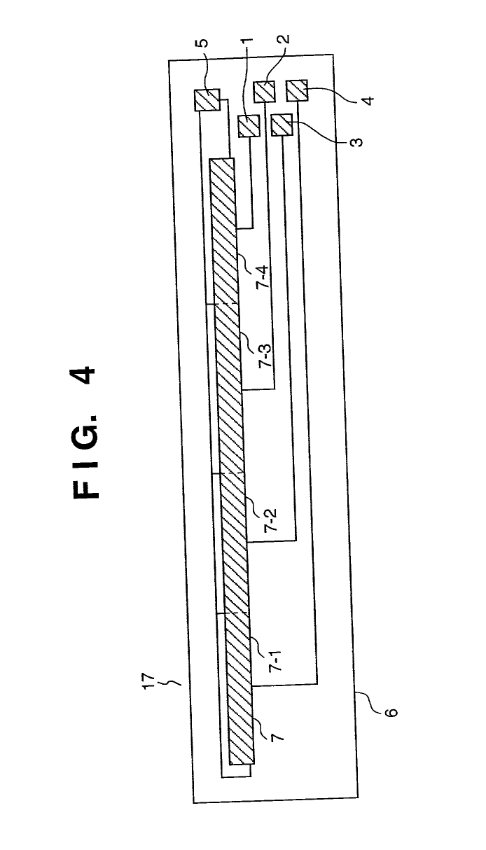

Next, a heater for heating the print sheet will be described. FIG. 4 shows the heater used in the printer of the present embodiment. A heater 17 has a heat generating resistor 7 on an alumina substrate 6 having a thickness of about 0.7 mm, a width of 7 mm and a length of 30 cm, although the size changes depending on the size of the printer. The heat generating resistor 7 is formed by coating paste of alloy powder of silver and palladium, or the like, into a slim line shape having a thickness of about 10 μm and sintering the paste. Further, a film having a thickness of about 10 μm is formed on the above line by coating the line with paste of borosilicate glass or the like having high insulation and sintering the paste. Further, a cover glass layer having a thickness of 10 μm is formed by coating the above film with paste of lead glass powder or the like and sintering the paste. The cover glass layer provides the heat generating resistor 7 with durability against abrasion caused when passing the print sheet. In FIG. 4, the heat generating resistor 7 is a single line divided into four segments 7-1 to 7-4 by wiring electrodes 1 to 5 at four parts. The segments are independently controlled.

FIG. 5 shows the wiring of the heater 17. The respective resistors are grounded via the electrodes 1 to 4 and drive transistors 8 to 11. The electrode 5 is connected to the power of the heater 17. When any of the transistors 8 to 11 is ON or in an operating state, current flows to a heat generating resistor connected to the collector of the transistor, and a heater segment including the resistor generates heat. If any of selection signals S1 to S4 is inputted via a heater selector 18 into the base of the corresponding transistor, the segment connected to the ON transistor generates heat. For example, if the transistor 8 is turned ON, current flows to the resistor connected to the collector of the transistor 8, and the heater segment 7-1 including the resistor generates heat.

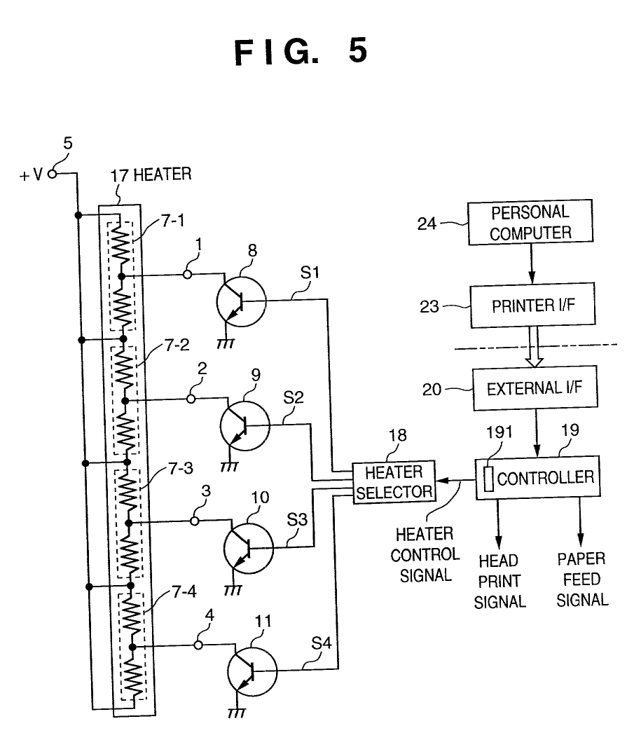

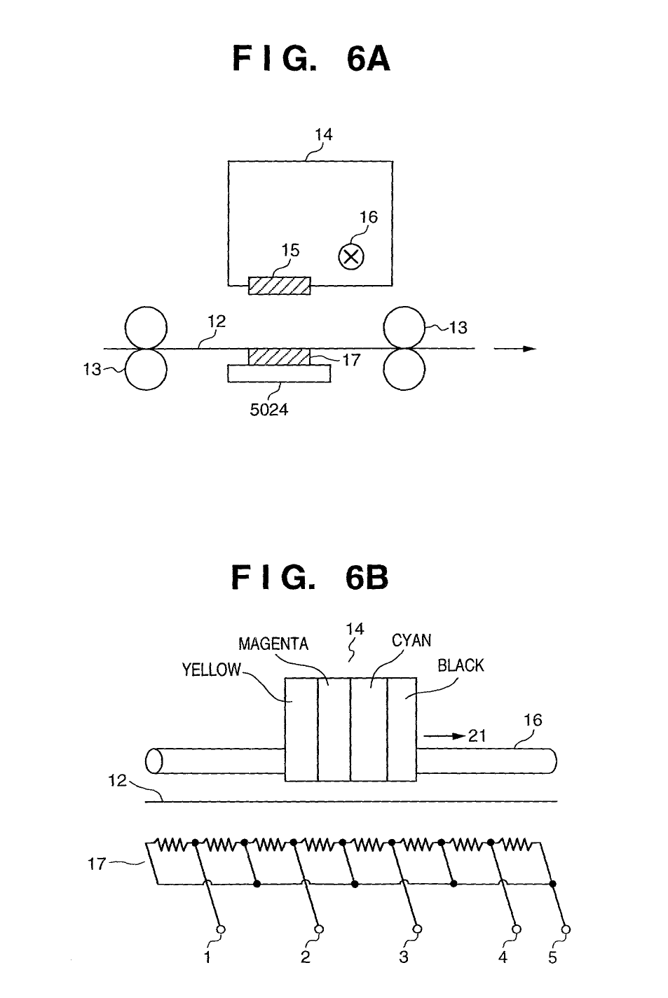

FIG. 6 schematically shows the arrangement of the printhead and the heater. In this printer, a print medium 12 is conveyed by conveyance rollers 13 while the print medium 12 comes :into contact with the heater 17 and the print medium 12 is heated from the rear surface side. On the other hand, the printhead 14 is guided by the lead screw 16 along a lengthwise direction of the heater 17, while sequentially discharging ink droplets from the nozzles 15 based on print information, thus forming an image on the print medium 12. Note that the lengthwise direction of the heater 17 is a direction vertical to the FIG. 6A and is represented by an arrow 21 in FIG. 6B. Further, paper feed is performed by a necessary amount via the conveyance rollers 13 or a feeding device, then the next line is printed by scanning of the printhead 14. At this time, the heater 17 at the rear side heats the paper to a predetermined temperature, thereafter, ink droplets discharged from the printhead 14 are attached to the paper.

In this case, the operation status of the heater 17 differs in accordance with image type. For example, to obtain a printed sheet 22 including an area A having a color complicated pattern such as a photograph or an image and a character area B, while a portion indicated by a length a passes over the heater 17 along the paper feed direction, the transistors 8 and 9, for example, are turned ON to electrify the heat generating resistors corresponding to the area A of the paper indicated by a widthwise direction b and cause the heater segments 7-1 and 7-2 to generate heat. This series of controls is made by a controller 19. That is, the controller 19 sends a signal to the heater selector 18 in synchronization with the paper feed control, based on print information including area designation information of the image received from an external device such as a personal computer 24 (See FIG. 5). The print information is sent from the personal computer 24 through, e.g., a printer cable according to the Centronics interface. Accordingly, a user only sets area designation (control information to control the heater 17 as a result) of an image for ink spread control, on a software such as a printer driver of a personal computer, in accordance with a document to be printed. Otherwise, it may be arranged such that the printer driver automatically discriminates an image area from a character or figure area and sets area designation, thus omitting the user's labor.

### <Heater Control>

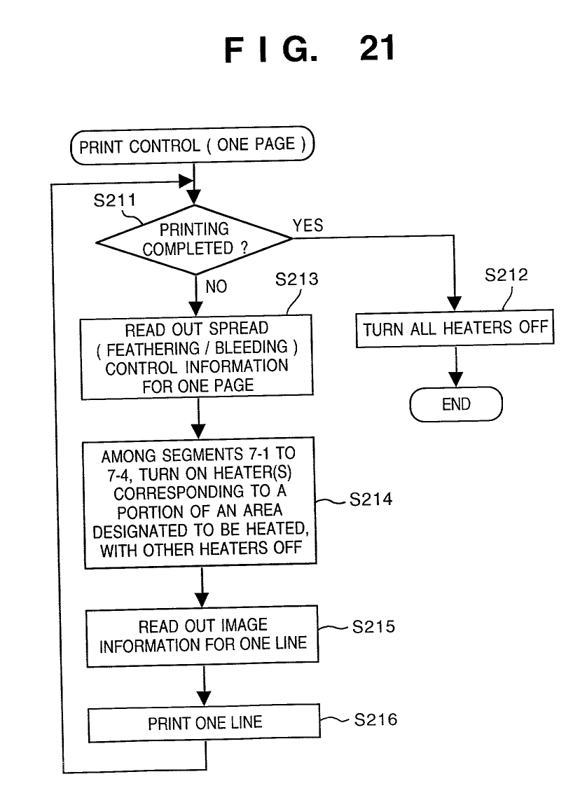

Next, procedures of controlling the heater will be described with reference to FIGS. 20 and 21 which are flowcharts showing the control procedures performed by the controller 19.

In FIG. 20, first, area designation information received with image information is read out (step S201). As the area designation information, image type such as natural image, character information and figure information may be designated, or the designation may be made by simply discriminating a natural image from other information, or designation may be made based on whether heating is performed or not. In a case where image data is received in the form of page description language, discrimination can be made based on the type of the data without specific designation.

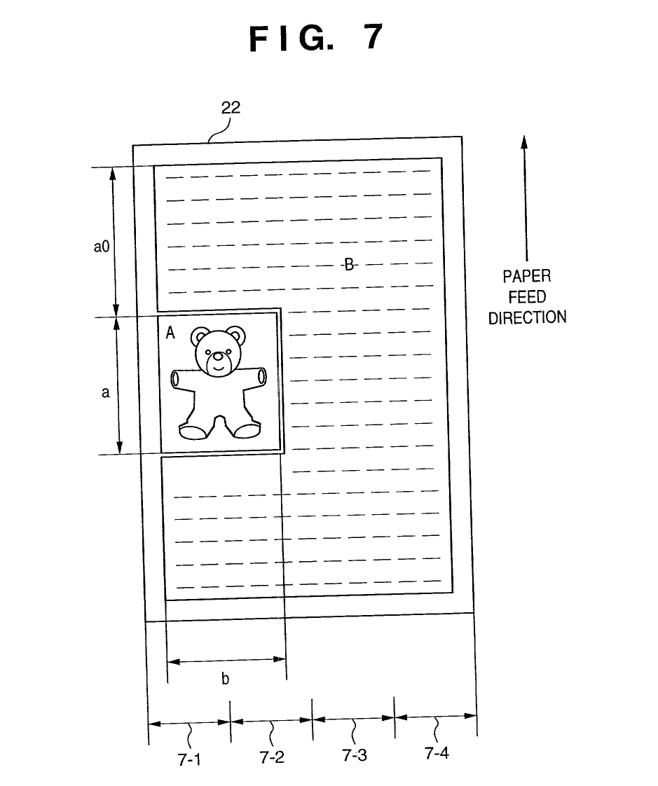

When the area designation information has been read out, spread control information, i.e., information indicating whether heating by each segment of the heater 17 is performed or not for ink spread control, is set based on the area designation information (step S202). For example, the control information is set such that heating is not performed with respect to areas of characters and line art, while heating is performed with respect to an area of bitmap image. In case of FIG. 7, the control information is set in accordance with image type such that heating is not performed with respect to a0 lines from the beginning of the page, then, with respect to a lines, heating is performed by electrifying the heater segments 7-1 and 7-2 corresponding to the width b, and with respect to the remaining lines, heating is not performed by the end of the page. In this example, as heating is performed by an area corresponding to a segment which is a ¼ part of the heater 17, as a unit, the control information is managed as binary information obtained by dividing information for one line (area printed by one scanning of the printhead) by four. If A4 sized one page is printed by 40 scannings, i.e., 40 lines, spread control information of 4×40=160 bits per page is set.

When the setting of the spread control information for the image to be printed has been completed (YES at step S203), the information is stored into a predetermined storage area 191 (See FIG. 5), and the procedure ends (step S204).

Note that the end of the segment of the heater 17 does not always correspond to the end of an image area. In this case, heating/non-heating is determined based on the ratio between image areas corresponding to one heater segment. In this example, heating/non-heating is determined while giving priority to larger area in this example.

FIG. 21 shows a control procedure by the controller 19 for the heater 17 and the printhead 14 for printing one page. First, before scanning, it is determined whether or not printing has been completed (step S211), and if the printing has been completed, all the heaters are turned off (step S212). If line(s) to be printed remains, 4-bit spread control information corresponding to the line to be printed is read from the storage area 191 (step S213). The information is outputted from the heater selector 18, and the transistor of segment(s) (any of the segments 7-1 to 7-4) corresponding to an area designated to be heated, is turned on, thus heating is performed (step S214). Thereafter, image information of the line to be printed is read out (step S215), and the line is printed (step S216). Since this procedure is for one page, in case of printing a plurality of pages, the procedure is repeated for the number of pages.

By the above controls, ink attached to a non-heated area slowly permeates into the paper, as shown in FIGS. 1 and 2 as the measurement results, thus a sharp character image without feathering is formed. On the other hand, ink attached to a heated area immediately permeates into the paper, so that it does not quickly mix with subsequently attached ink, thus an image having excellent color development without bleeding is formed. In this manner, both high-quality image printing and high-quality character printing can be realized. In the image in FIG. 7, heating is performed with respect to the natural image area A, while heating is not performed with respect to the character area B. Ink quickly permeates into the paper at the natural image area A, thus forming a high-quality image where bleeding is suppressed, while ink does not quickly permeate into the paper at the character area B, thus characters with sharp outlines and without feathering can be printed.

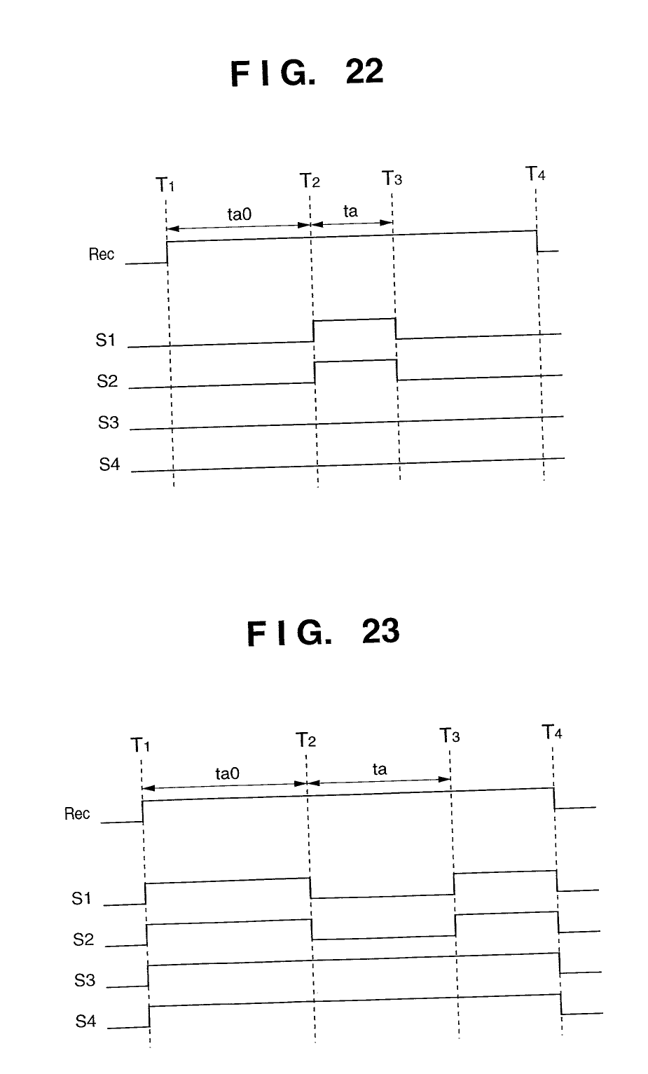

FIG. 22 is a timing chart showing heater control when printing a document in FIG. 7. When signals are applied to the selection signal lines S1 to S4, the transistors 8 to 11 corresponding to the respective signals become ON, the heater segments 7-1 to 7-4 are electrified, and the heater segments generate heat. In FIG. 22, when a signal Rec which indicates that printing is performed with respect to a print sheet becomes ON at timing T1, printing is started. Thereafter, when a period ta0 for conveying the print sheet by the length a0 has elapsed, the signals S1 and S2 become ON at timing T2. This state is maintained for a period ta for conveying the print sheet by the length a, and the signals S1 and S2 become OFF at timing T3. Accordingly, the heater segments 7-1 and 7-2 generate heat while printing is performed by the length a from timing T2 to timing T3. Thereafter, the printing ends in the state where all the heaters are OFF.

In this manner, ink spread can be controlled by the heater.

In the experiment where the Canon ink-jet printer BJC820J was improved and the ink having the characteristics represented as the measurement results shown in FIGS. 1 and 2 was used, spread control is greatly effective when the surface temperature of the heater 17 is about 90° C. The higher the temperature, the greater the effect of the spread control becomes, however, it is desirable that the temperature is low from the point of energy saving. Accordingly, the temperature may be determined in consideration of the arrangement of ink, the design of the printer and printing effect. For example, the ink having characteristics represented as the measurement results in FIG. 3 has very quick permeability, therefore, spread control is not effective at a low temperature, however, an image with a very high quality can be obtained when the temperature is set to 200° C. Note that at a high temperature, if paper jam or the like occurs, the paper may burn. For this reason, addition of penetrating agent to ink must be controlled in consideration of the above situation.

As described above, the ink-jet printer of the present invention controls the permeation of ink by controlling to totally or partially heat the surface of paper in accordance with the feathering/bleeding control information, and printing effect which more satisfactorily respond the user's intention can be attained. In the present embodiment, feathering and bleeding have been described as undesirable effects, however, these effects should be evaluated by the user, and it is more desirable that the user can control the feathering and bleeding in accordance with his/her preference. The printer of the present invention is intended to control physical characteristics of ink by heating paper in accordance with an image part so as to obtain various effects. Thus, an effect utilizing spread, for example, can be enhanced in an image.

Further, as proposed in Japanese Patent Application Laid-Open No. 8-333534 by the present inventor, a further improved effect can be attained by using ink having a high polymer agent which has a reversible viscosity-improving characteristic with respect to heat. This high polymer agent dissolves in water at a low temperature, however, phase separation occurs at a predetermined or higher temperature, separates from the water and shows high viscosity. The ink is not different from ordinary ink until it is discharged from an ink-jet printer, however, on a print medium having an increased temperature, fixes color matter on the surface layer of the print medium with is viscosity. At this time, as the temperature of the print medium is high, the permeability of the ink is suppressed, thereby characters can be printed with high quality. In this case, the driving patterns shown in FIG. 23 for the heater segments 7-1 to 7-4 are appropriate for printing image of FIG. 7. In this method, as the temperature causing phase separation can be freely controlled by controlling combination of the high polymer and water, the permeability of ink with respect to a print medium can be easily controlled and a remarkably improved effect can be expected by combining this ink with the heating method of the present invention. In this case, the heating method must be appropriate to the ink.

In this manner, it is preferable to generate spread control data in accordance with the characteristics of ink. Further, as the permeation of ink with respect to a print medium changes corresponding to the characteristics of the print medium, it is also preferable to generate spread control data in accordance with the characteristics of the print medium. Further, it is more preferable to generate spread control data based on at least two of the type of image, the characteristics of ink and the characteristics of paper. Further, by applying the present invention to an ink-jet printing using ink containing a diffused pigment, dispersive destruction of the pigment can be caused by heat. By controlling the dispersive destruction of the pigment, the pigment can be totally or partially fixed to the surface of a print medium, which greatly improves possibilities of printing expressions. It is also possible to use both the pigment and a dye.

### [Other Embodiments]

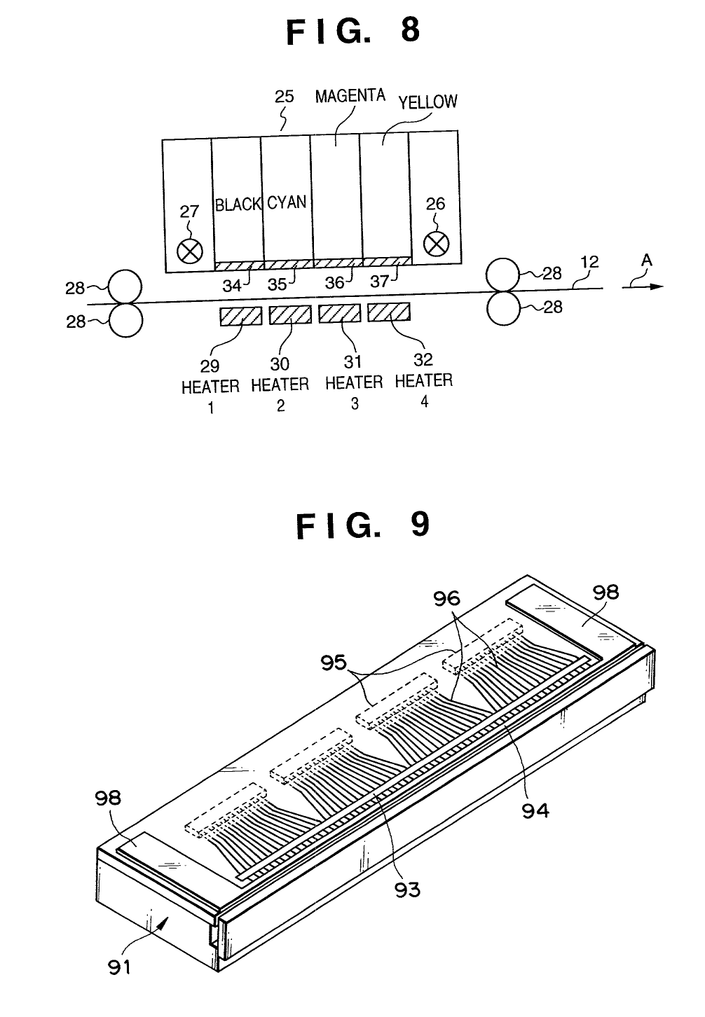

FIG. 8 shows another embodiment of the present invention. In this example, heads 34 to 37 for discharging ink of respective colors are arrayed in a direction vertical to lead screws 26 and 27, i.e., a sheet conveyance direction. That is, four adjacent scan lines can be printed in different colors by one scanning of the printhead. Each color head appropriately has an array of plural nozzles. In this construction, a plurality of heaters 29 to 32 can be arrayed along the sheet conveyance direction, for ink spread control for respective colors. The amount of information is large (four times greater than that in the first embodiment) because the spread control information for controlling the heater is required for the respective colors, however, printing quality for images of the respective colors is improved.

FIG. 9 shows another embodiment of the present invention. In this example, the heater 17 of the first embodiment is replaced with a line type head which is used in so-called thermal transfer type and sublimation type printers. In FIG. 9, a line heat generating resistor 93, which is covered with a protective layer, is provided in a direction orthogonal to a scanning direction of the printhead on an insulating substrate 91. Regarding a line direction, the heat generating resistor 93 has a width corresponding to one pixel of the printhead, and regarding a height (subscanning) direction, it has a width corresponding to the width of one scan line, i.e., the width of the nozzle array of the printhead. The respective heat generating resistors for one scan line are connected to a common electrode 94 and separate electrodes 96, and are driven by a drive IC 95 which drives the respective heat generating resistors connected to the separate electrodes 96. The driving principle of the drive IC 95 is similar to that of the heater selector 18 and the transistors 8 to 11 shown in FIG. 7, and it can be considered that in this case, the heater segments 7-1 to 7-4 respectively have a width corresponding to a printing element of the printhead. A power supply electrode 98 applies a predetermined drive voltage to the common electrode 94.

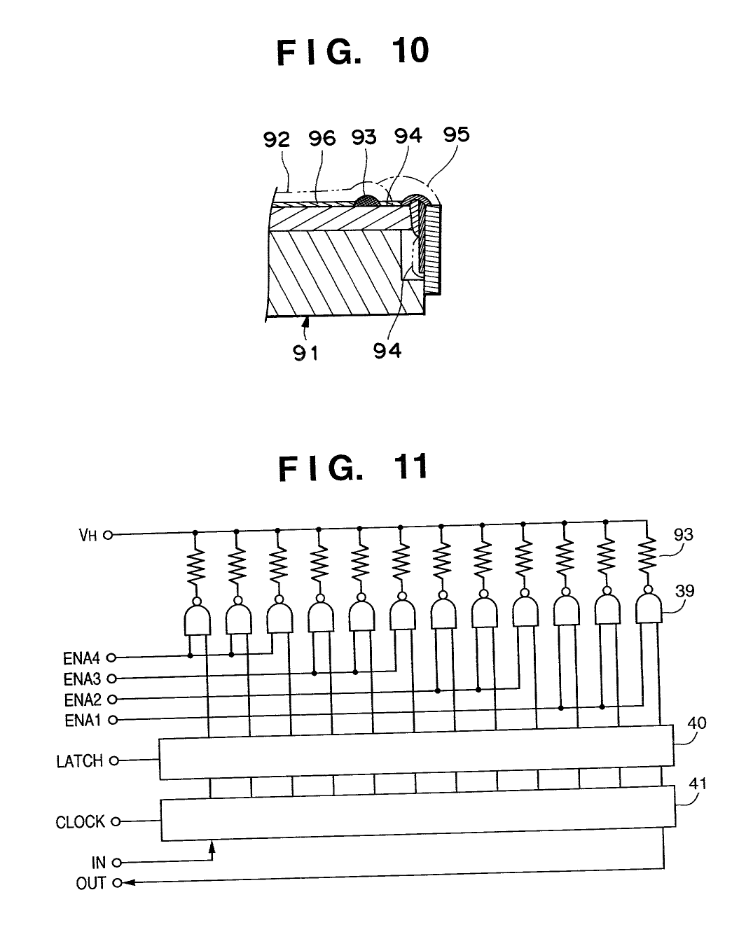

FIG. 10 shows the cross section of this printhead. In FIG. 10, the elements corresponding to those in FIG. 9 have the same reference numerals. The heat generating resistor 93 is covered with glass coat 92. The electrode 94 and the like not in contact with the heat generating resistor 93 are covered with resin coat 95.

By using this heater, regarding the subscanning direction, the permeation of ink can be controlled by pixel units. In this case, the spread control information set at steps S202 and S204 in FIG. 20 is has a binary value indicative of heating/non-heating corresponding to one pixel width.

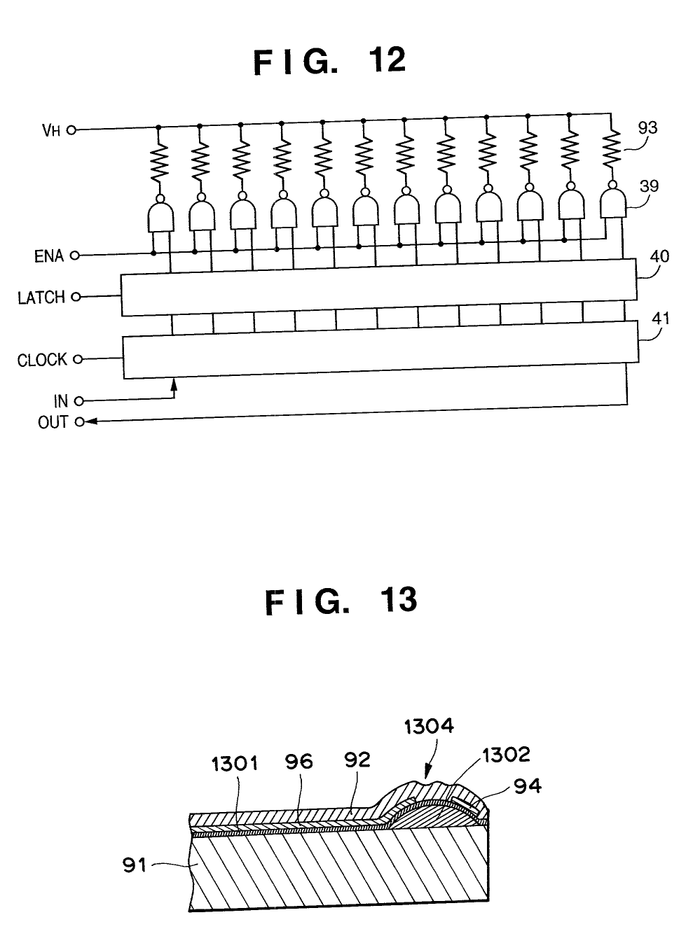

FIGS. 11 and 12 show examples of driver circuits for this type of heater. The heat generating resistor 93 performs control by inputting a signal stored in a shift register 41 via a latch 40 into a gate 39 which is controlled by an enable signal. The shift register 41 receives a signal indicating a heater to be turned on. In this example, as the number of heaters is very large (e.g., 360 dpi) in comparison with those in FIG. 5, finer ink spread control is possible. FIG. 12 shows an example where an enable signal is commonly used for all the heat generating resistors. This attains simple construction and control, however, in case of large number of heat generating resistors, increases the amount of heat generation and electric consumption of the circuit.

FIGS. 13 to 16 show cross-sections of heaters used in these embodiments. In FIG. 13, a glaze layer 1302 is formed on the substrate 91, and a resistive film 1301 is formed on the glaze layer 1302. The resistive film 1301 is connected to the common electrode 94 and the separate electrodes 96, and connected to the circuit as described in FIG. 9 for a similar control. The top of the resistive film 1301 is a heat generating portion 1304. The heat generating portion 1304 is covered with a protective film 92.

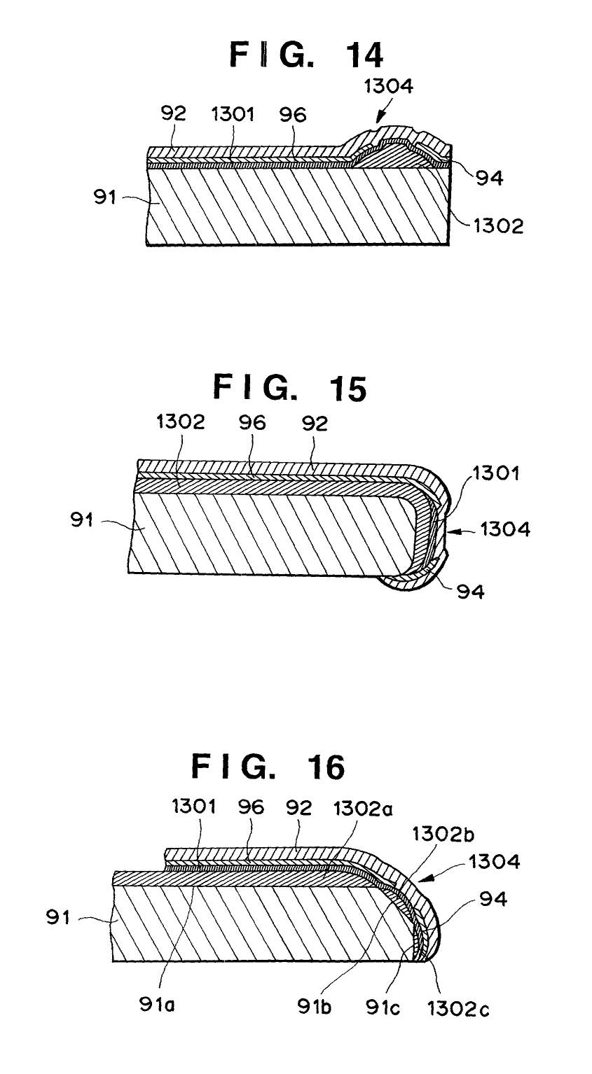

In FIGS. 14 and 15, the elements corresponding to those in FIG. 13 have the same reference numerals. In these figures, the position and the entire shape of the heat generating portion 1304 is different from that in FIG. 13, and the shape of the heater can be selected from various shapes in accordance with the construction and shape of the ink-jet printer.

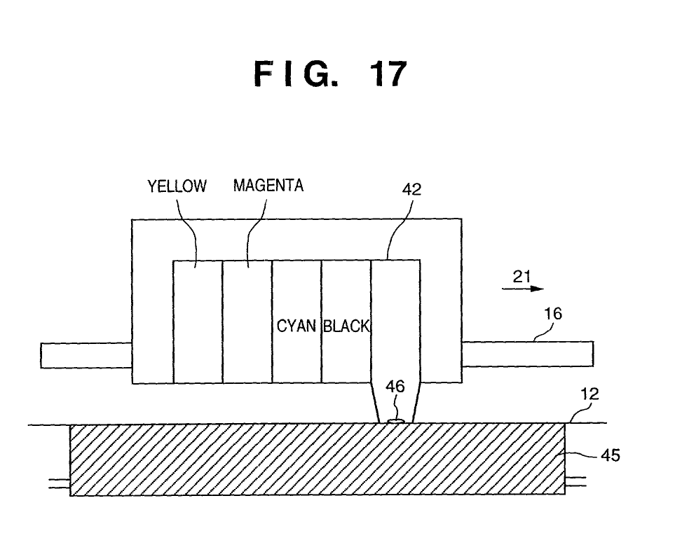

FIG. 17 shows another embodiment of the present invention. In this example, a heater 46 utilizes a thermal-transfer type printhead similar to the above example. Note that the heater 46 utilizes, not the line-type but a scanning-type thermal-transfer printhead. A printhead 42 has heads for discharge respective black ink, cyan ink, magenta ink and yellow ink, and the heater 46 at a position as the head of scanning. The heater 46 has a length corresponding to the width of the nozzle array of the head in the sheet conveyance direction. The heater 46 may be a single heater having the above length or may be a plurality of heaters each having a width corresponding to a print pixel and may be independently controlled. The heater 46, opposite to a platen 45, rubs the print medium 12 and heats the surface of the print medium, so as to perform ink spread control in accordance with spread control information. This method attains a good heat efficiency because the print medium is heated from the printed surface side.

Further, in a case where the printhead scans in back-and-forth directions, the heater 46 may also be provided at the left side of the yellow head, and heater to be used is changed in accordance with the scanning direction.

As described above, the ink-jet printer of the embodiments controls ink spread with respect to paper, in accordance with image type. This prevents bleeding, regarding a natural image where a plurality of color ink is used to print closely adjacent portions, while prevents feathering of outlines by slowing permeation of ink, regarding an image where characters or the like are to be clearly printed, thus print-outputs high quality images.

### [Further Embodiments]

The present invention can be applied to a system constituted by a plurality of devices (e.g., host computer, interface, reader, printer) or to an apparatus comprising a single device (e.g., copy machine, facsimile).

Further, the object of the present invention can be also achieved by providing a storage medium storing program codes for performing the aforesaid processes to a system or an apparatus, reading the program codes with a computer (e.g., CPU, MPU) of the system or apparatus from the storage medium, then executing the program.

In this case, the program codes read from the storage medium realize the functions according to the embodiments, and the storage medium storing the program codes constitutes the invention.

Further, the storage medium, such as a floppy disk, a hard disk, an optical disk, a magneto-optical disk, CD-ROM, CD-R, a magnetic tape, a non-volatile type memory card, and ROM can be used for providing the program codes.

Furthermore, besides aforesaid functions according to the above embodiments are realized by executing the program codes which are read by a computer, the present invention includes a case where an OS (operating system) or the like working on the computer performs a part or entire processes in accordance with designations of the program codes and realizes functions according to the above embodiments.

Furthermore, the present invention also includes a case where, after the program codes read from the storage medium are written in a function expansion card which is inserted into the computer or in a memory provided in a function expansion unit which is connected to the computer, CPU or the like contained in the function expansion card or unit performs a part or entire process in accordance with designations of the program codes and realizes functions of the above embodiments.

Further, in the above embodiments, spread control data is generated in consideration of spread of ink, that is, feathering, bleeding or the like, however, it may be arranged such that permeation control data is generated in consideration of permeation of ink with respect to a print medium.

Further, in the above embodiments, binary data is employed as the control data to turn on/off the heater, however, multivalued data may be employed for multiple-step control on heating state of the heater. In this case, finer heating control can be performed.

The present invention is not limited to the above embodiments and various changes and modifications can be made within the spirit and scope of the present invention. Therefore, to appraise the public of the scope of the present invention, the following claims are made.

What is claimed is:

1. An ink-jet printer which prints an image by using printing means for discharging ink on a print medium, comprising:
heating means for heating a predetermined area of the print medium;
storage means for storing control information to control spread of the image to be printed on the print medium, in correspondence with image information; and
control means for controlling said heating means to heat an area of the print medium, on which the image is printed based on the image information, in accordance with the control information.

2. The ink-jet printer according to claim 1, further comprising control-information generating means for generating the control information based on the type of the image information of the image to be printed.

3. The ink-jet printer according to claim 2, wherein said control-information generating means generates the control information to heat an area including a natural image, while not to heat other areas.

4. The ink-jet printer according to claim 3, wherein said printing means performs printing by using ink which quickly permeates into the print medium if the print medium has a high temperature while does not quickly permeate into the print medium if the print medium has a low temperature.

5. The ink-jet printer according to claim 2, wherein said control-information generating means generates the control information not to heat an area including a natural image, while to heat other areas.

6. The ink-jet printer according to claim 5, wherein the ink quickly permeates into the print medium if the print medium has a low temperature while does not quickly permeate into the print medium if the print medium has a high temperature.

7. The ink-jet printer according to claim 2, wherein said control-information generating means generates the control information based on an instruction from a user.

8. The ink-jet printer according to claim 2, wherein said control-information generating means generates the control information based on a characteristic of the print medium.

9. The ink-jet printer according to claim 1, wherein said printing means print-outputs an image in line units, and wherein said heating means has a plurality of heaters which independently heat a plurality of portions in one line.

10. The ink-jet printer according to claim 9, wherein said heaters heat the one line in pixel width units.

11. The ink-jet printer according to claim 11 wherein said heating means heats the print medium from a rear surface side while printing is performed with respect to the print medium.

12. The ink-jet printer according to claim 1, wherein said heating means heats a print surface of the print medium prior to printing by said printing means.

13. The ink-jet printer according to claim 1, wherein said printing means has a plurality of color heads which independently discharge a plurality of color ink, and print-outputs a color image by scanning said color heads.

14. The ink-jet printer according to claim 13, wherein said heating means has a plurality of heaters corresponding to the plurality of color heads.

15. The ink-jet printer according to claim 13, wherein said color heads are heads of respective colors arrayed in a scanning direction.

16. The ink-jet printer according to claim 13, wherein said color heads are heads of respective colors arrayed in a direction orthogonal to a scanning direction.

17. The ink-jet printer according to claim 1, wherein said printing means discharges ink droplets by applying thermal energy to ink.

18. A printing method which prints an image by using printing means for discharging ink on a print medium comprising the steps of:
providing heating means for heating means for heating a predetermined area of the print medium,
storing control information to control spread of the image to be printed on the print medium, in correspondence with image information;
controlling the heating means to heat an area of the print medium, on which the image is printed based on the image information, in accordance with the control information, and printing the image in accordance with the image information.

19. The printing method according to claim 18, further comprising the step of generating the control information based on the type of the image information of the image to be printed, prior to said controlling step.

20. The printing method according to claim 19, wherein at said generating step, the control information is generated to heat an area including a natural image, while not to heat other areas.

21. The printing method according to claim 20, wherein at said printing step performs printing by using ink which quickly permeates into the print medium if the print medium has a high temperature while does not quickly permeate into the print medium if the print medium has a low temperature.

22. The printing method according to claim 19, wherein at said generating step, the control information is generated not to heat an area including a natural image, while to heat other areas.

23. The printing method according to claim 22, wherein the ink quickly permeates into the print medium if the print medium has a low temperature while does not quickly permeate into the print medium if the print medium has a high temperature.

24. The printing method according to claim 19, wherein at said generating step, the control information is generated based on an instruction from a user.

25. The printing method according to claim 19, wherein at said generating step, the control information is generated based on a characteristic of the print medium.

26. The printing method according to claim 18, wherein said printing step prints the image in line units, and said controlling step heats heat a plurality of portions in one line independently.

27. The printing method according to claim 26, wherein said controlling step, heats one line in pixel width units.

28. The printing method according to claim 18, wherein said controlling step prints, a color image by controlling a plurality of color heads which independently discharge a plurality of color ink.

29. The printing method according to claim 28, wherein the heating means has a plurality of heaters corresponding to the plurality of color heads.

30. The printing method according to claim 18, wherein at said print control step, thermal energy is applied to ink so as to discharge ink droplets.

31. An ink-jet printer which prints an image by using an ink-jet head which discharges ink, comprising:
a heater provided opposite to a position of printing by said ink-jet head;
a memory which stores control information to control spread of the image to be printed on a print medium, in correspondence with image information; and
a heater controller which controls said heater in accordance with control information.

32. The ink-jet printer according to claim 31, further comprising control-information generator for generating the control information based on the type of the image information of the image to be printed.

33. The ink-jet printer according to claim 32, wherein said control-information generator generates the control information to heat an area including a natural image, while not to heat other areas.

34. The ink-jet printer according to claim 33, wherein the ink-jet head performs printing by discharging ink which quickly permeates into the print medium if the print medium has a high temperature while does not quickly permeate into the print medium if the print medium has a low temperature.

35. The ink-jet printer according to claim 32, wherein said control-information generator generates the control information not to heat an area including a natural image, while to heat other areas.

36. The ink-jet printer according to claim 35, wherein the ink quickly permeates into the print medium if the print medium has a low temperature while does not quickly permeate into the print medium if the print medium has a high temperature.

37. The ink-jet printer according to claim 32, wherein said control-information generator generates the control information based on an instruction from a user.

38. The ink-jet printer according to claim 32, wherein said control-information generator generates the control information based on a characteristic of the print medium.

39. The ink-jet printer according to claim 31, wherein said ink-jet head print-outputs an image in line units, and wherein said heater independently heats a plurality of portions in one line.

40. The ink-jet printer according to claim 39, wherein said heater heats the one line in pixel width units.

41. The ink-jet printer according to claim 31, wherein said heater heats the print medium from a rear surface side.

42. The ink-jet printer according to claim 31, wherein said heater heats a print medium from the print surface prior to printing by said ink-jet head.

43. The ink-jet printer according to claim 31, wherein said ink-jet head has a plurality of color heads which independently discharge a plurality of color ink,
and wherein said heater has a plurality of heaters corresponding to the plurality of color heads.

44. The ink-jet printer according to claim 31, wherein said ink-jet head discharges the ink droplets by applying thermal energy to ink.

45. The ink-jet printer according to claim 1, wherein the control information is binary data for on/off control on said heating means.

46. The ink-jet printer according to claim 1, wherein the control information is multivalued data for multi-step controlling a temperature of heating by said heating means.

47. The ink-jet printer according to claim 1, wherein said control information is to control feathering of ink on the print medium.

48. The ink-jet printer according to claim 1, wherein said control information is to control bleeding of ink on the print medium.

49. The printing method according to claim 18, wherein the control information is binary data for on/off control on said heating means.

50. The printing method according to claim 18, wherein the control information is multivalued data for multi-step controlling a temperature of heating by said heating means.

51. The printing method according to claim 18, wherein said control information is to control feathering of ink on the print medium.

52. The printing method according to claim 18, wherein said control information is to control bleeding of ink on the print medium.

53. The ink-jet printer according to claim 31, wherein the control information is binary data for on/off control on said heater.

54. The ink-jet printer according to claim 31, wherein the control information is multivalued data for multi-step controlling a temperature of heating by said heater.

55. the ink-jet printer according to claim 31, wherein said control information is to control feathering of ink on the print medium.

56. The ink-jet printer according to claim 31, wherein said control information is to control bleeding of ink on the print medium.

57. An ink-jet printer which prints an image by using printing means for discharging ink on a print medium, comprising:
heating means for heating a predetermined area of the print medium;
storage means for storing control information to control permeation of the image to be printed on the print medium, in correspondence with image information; and
control means for controlling said heating means to heat an area of the print medium, on which the image is printed based on the image information, in accordance with the control information.

58. A printing method for an ink-jet printer which prints an image by using printing means for discharging ink on a print medium, and heating means for heating a predetermined area of the print medium comprising:
a storage step of storing control information to control permeation of the image to be printed on the print medium, in correspondence with image information; and
a print control step of controlling the heating means to heat an area of the print medium, on which the image is printed based on the image information, in accordance with the control information.

59. An ink-jet printer which prints an image by using an ink-jet head which discharges ink, comprising:
a heater provided opposite to a position of printing by said ink-jet head;
a memory which stores control information to control permeation of the image to be printed on a print medium, in correspondence with image information; and
a heater controller which controls said heater in accordance with control information.
